(19) United States
(12) Patent Application Publication
(10) Pub. No.: US 2004/0083378 A1
(43) Pub. Date: Apr. 29, 2004

(54) Method, systems and devices for handling files while operated on in physically different computer devices

(75) Inventor: Jeffrey W. LeRose, Cary, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: Research Triangle Software, Inc., Cary, NC

(21) Appl. No.: 10/425,899

(22) Filed: Apr. 30, 2003

Related U.S. Application Data
(60) Provisional application No. 60/421,983, filed on Oct. 29, 2002.

(51) Int. Cl. H04L 9/00

(52) U.S. Cl. 713/193

(57) ABSTRACT

A method for protecting at least one file on a memory device includes the steps of attaching the memory device to an origin computer, wherein a file is located on the origin computer and accessible through the attached memory device. The user then operates software resident on the memory device via the origin computer and designates the file to be transported to the memory device. The user selects a password and commands the device to encrypt the file. The file is compressed and encrypted, and subsequently saved on the device. The user disconnects the device and attaches it to another computer. By operating the deice software on another computer, the user selects the file and enters the password. The software decrypts the file and expands it. The file is saved to the memory device or the computer. The device may be detached again for further use.

### CROSS-REFERENCE TO RELATED APPLICATIONS

This application claims priority to U.S. provisional patent application No. 60/421,983 filed Oct. 29, 2002, which is incorporated herein by reference in its entirety.

### BACKGROUND OF THE INVENTION

1. Field of the Invention

The invention relates to a method, system and devices for handling files a computer user wishes to protect, while transporting the files from one computer system to another computer system. More specifically, the method, system and devices allow the files to be encrypted, compressed, and loaded to a portable physical computer device capable of connection to virtually any computer on which the files are to be used.

2. Description of the Background

Currently, a user operating on computer files such as data files or the like has limited options for securing such files transferred for operation on another computer system, such as a stand-alone personal computer. If the user desires to secure the files, these files can be secured in part by limiting access to the computer system and requiring appropriate user ID and password entries. While this approach provides some security to the files when limited to the use of a single computer system, the transfer and subsequent operation of the files on another computer presents additional security issues. To date, there has been no simple and effective way to move such files to a different computer system and maintain security. For example, in the case where a user is traveling, and operates on the files on a different computer system or a personal computer other than that of the user, the user subjects the files to security and privacy concerns.

One conventional approach to this problem includes the use of a disk for downloading encrypted information from specific terminals. The terminals are authorized to read the encrypted files. This approach does not, however, enable a user to utilize a terminal that is not previously authorized to read the encrypted files.

Another conventional approach discloses recording and encrypting data onto a portable device. While the data may be protected on the device, a user cannot utilize the device with any personal computer. The device must be brought to an authorized computer for decryption operation of the files.

In accordance with the method, devices and system described herein, the problem of operating such files on different stand-alone computer systems is overcome, while allowing such files to remain secure and protected and accessible only by the user-owner of the files.

### SUMMARY OF THE INVENTION

In one aspect of the present invention, there is provided in the embodiments herein a method implemented through software which provides encryption-based privacy. In accordance with the method, files are compressed and/or expanded, as well as encrypted and decrypted in a simple manner.

In one embodiment, the software that provides the compression/expansion and encryption/decryption functionality is made resident on a memory device, for instance, a diskette, re-writable or writable compact disc (CD), Zip® disk data storage media, or alternatively, a portable physical computer device such as a Memory Stick® portable memory device or other storage media capable of being connected to any computer having a Universal Serial Bus (USB) interface port. The software is loaded on the memory device, ensuring compatibility on any personal computer. Utilizing the software, the user designates the files to be transported, and then encrypts them for transport. When the files are needed, they are decrypted from the memory device.

In a second embodiment of the present invention, a method of a user securing a computer file comprises the step of applying a memory device to a first computer. The user then operates the software on the memory device to read the computer file. The computer file is then transferred to the memory device from the computer. The software on the memory device encrypts the computer file. The user may then remove the memory device and connect the device to a second computer. The software on the memory device then decrypts the file for use.

Further to the second embodiment, the software on the memory device may identify a file extension to determine whether the file is already encrypted or needs to be decrypted. The file may also be compressed before encryption. In the process of encryption, the software selects strings of characters from the file of approximately 2 to 127 identical bytes, wherein those bytes are then represented as a 2-byte value in a compressed output file corresponding to the original file. As a result, the device then expands a file that has been decrypted.

In a third embodiment, the software on the memory device has an operating system that operates when run on a personal computer. The method of operation of the software comprises the steps of designating a file to be encrypted/decrypted, designating an output file directory, supplying a password by the user, wherein the password is verified to ensure it has been entered correctly by the user, and translating the file into an encrypted format. The software is independent from the operating system of the computer operating system except for a user interface.

According to a fourth embodiment, the present invention provides a method for protecting at least one file on a memory device, including attaching the memory device to an origin computer, wherein the file is located on the origin computer, and wherein the files are accessible through the software loaded on the attached memory device. The user then operates the software resident on the memory device via the origin computer and designates the file to be transported. The user selects a password and commands the software to encrypt the designated file. The software compresses and encrypts the designated file. The designated file is saved in a designated folder on the memory device. The memory device is disconnected from the origin computer and connected to a destination computer. The user then operates software resident on the memory device via the destination computer and selects a file on the memory device. The user enters the password and commands the software to decrypt the file. The software decrypts and expands the file to a designated folder on the memory device. The file is saved to the memory device, the origin computer, or the destination computer. The user then disconnects the memory device from the destination computer.

According to a fifth embodiment of the present invention, the memory device secures files to be accessed on a personal computer, allowing a user to transport the memory device from a first computer to at least a second computer. The memory device comprises a portable device removably attached to the computer and software loaded on the portable device capable of encryption and decryption, wherein the software is operated from the device. The portable device removably attaches to the computer at a universal serial bus port. Alternatively, the portable device removably attaches to the computer using wireless or Firewire® multimedia application connectivity. The portable device is at least one of a compact disc, a re-writable compact disc, a writable compact disc, a Memory Stick® portable storage media, a mobile phone, a Zip® disk data storage media, a floppy disk, a personal digital assistant, and a portable e-mail device.

Further to the above embodiments, the software further comprises a preloaded file structure utilizing operating system utilities. The preloaded file structure comprises at least two file directories including an encrypted file directory and a non-encrypted file directory, wherein the files in the encrypted file directory are created for transport and decrypted in into the non-encrypted file directory by a target computer.

Having thus described generally the invention, the same will become better understood from the following detailed discussion.

### BRIEF DESCRIPTION OF THE DRAWINGS

In the Figures:

FIG. 1 shows a method of encrypting files to the memory device according to an embodiment of the present invention;

FIG. 2 shows a method of decrypting files from the memory device according to an embodiment of the present invention; and

FIG. 3 shows a user interface operation screen of the software according to an embodiment of the present invention.

### DETAILED DESCRIPTION

The present invention provides a new method and device for protecting files while transporting the files from one computer to another computer. By utilizing a memory device of the present invention, the user may obtain a file, encrypt the file, and transport it to virtually any computer for decryption. The memory device is loaded with the encryption-based privacy software to ensure the most complete security and compatibility.

A preferred embodiment of the memory device of the present invention includes two components: a portable component and software loaded on the portable component. The portable component may be applied to the computer by various means, as known in the art, to provide means of simple installation and disconnection. A preferred method utilizes a universal serial bus (USB) interface port. Personal computers are often equipped with USB ports for simple installation of computer devices. By connecting the portable component to the USB port, a user may operate the personal computer to command the attached component. Other such connections include wireless connectivity or Firewire® multimedia application (1394 standard) connectivity. An advantage to using such a connection is the ability to rapidly and efficiently transfer the portable component from one computer to another computer.

In one embodiment exemplifying the use of a USB port, the memory device has three components including a USB flash drive, software, and a preloaded file structure. The USB Flash Drive is a compact, light, and portable storage device. It is plugged into any USB port, and looks and functions just like another hard-drive. This is the preferred type of memory device for use with the invention. 32 Mb, 64 Mb, and 128 Mb sizes are available, but there is almost no limit to the amount of storage possible.

In a preferred aspect, the memory devices are devices such as are available from USBKeyDrive, with additional details about such memory devices available at the web site www.usbkeydrive.com, the disclosure of which website as visited on Apr. 9, 2003, is incorporated by reference herein.

There are a large number of advantages to the use of this system and the memory device. When dealing with insecure computers, all files and programs (including the programs using the decrypted data) can be kept only on the memory device. Since software is already loaded on the memory device there is no need to have the software on any computer. The memory devices are commercially available and come in various memory sizes, from 16 Mb to 2 Gb, so files and programs of many sizes can be accommodated. At the larger sizes, the memory device can be used for off-site secure storage of other files as well as those involved in this process.

In an alternative embodiment, the memory device may contain two components, one or both being portable in nature. In addition to a first component as described above, a disk, a Memory Stick® portable storage media, or the like, may be utilized with the first component. One advantage to using a two component memory device over the embodiment with one component is that the user may more easily transport a portable media or disk than a component with an integrated hard drive. Additionally, utilizing numerous hard drives can potentially provide more memory storage than the limited space in a portable component hard drive. Using a component such as a Memory Stick® portable storage media enables easy transportation of files by a person who could carry the portable media on a key ring or place it in a pocket. Instead of carrying around a laptop to ensure security of encrypted files, the user simply needs to only carry the compact component. For a traveler who needs to deliver a presentation in another location, a secure portable component is the ideal solution for transporting confidential documents.

Another such embodiment of the memory device includes the use of a compact disc (CD), preferably a writable CD (CD-R) or a re-writable CD (CD-RW), a Zip® disk data storage media, a floppy disk, or any other removable memory media known to one of ordinary skill in the art. In this embodiment, the CD, or similar apparatus, is substantially the whole memory device. Accessing the CD, or similar device, via the computer provides similar results to the portable component described herein. The utilization of removable memory media devices allows the user compatibility with many possible workstations. For instance, it is possible to implement the system on a conventional diskette. For instance, it is possible to implement the system utilizing removable memory media which can be inserted and read on a personal computer through the use of its diskette drive, for example, the drive typically designated as Drive A. In addition, the method and system can be implemented on mobile or cellular telephones, personal digital assistants (PDA's) or a wireless e-mail device, such as a Blackberry°, using wireless or Firewire® multimedia application connectivity.

The memory device, utilizing any means of connectivity or recording described herein or known in the art, provides software for securely handling files. The memory device is provided with the compression/encryption software loaded thereon, allowing the user to designate the files to be transported, and then encrypting them for transport. In an embodiment disclosing a portable component, such as one connected to a USB port, the software is resident on the portable component. Alternatively, in a memory device comprising a Memory Stick® portable storage media, for example, the software may be resident on the Memory Stick® or the first component. In a third embodiment disclosing a CD, for example, the software is resident on the CD. When the files are needed, they are decrypted from the memory device. In yet another alternative embodiment, the memory device is resident on the computer as a processor or software.

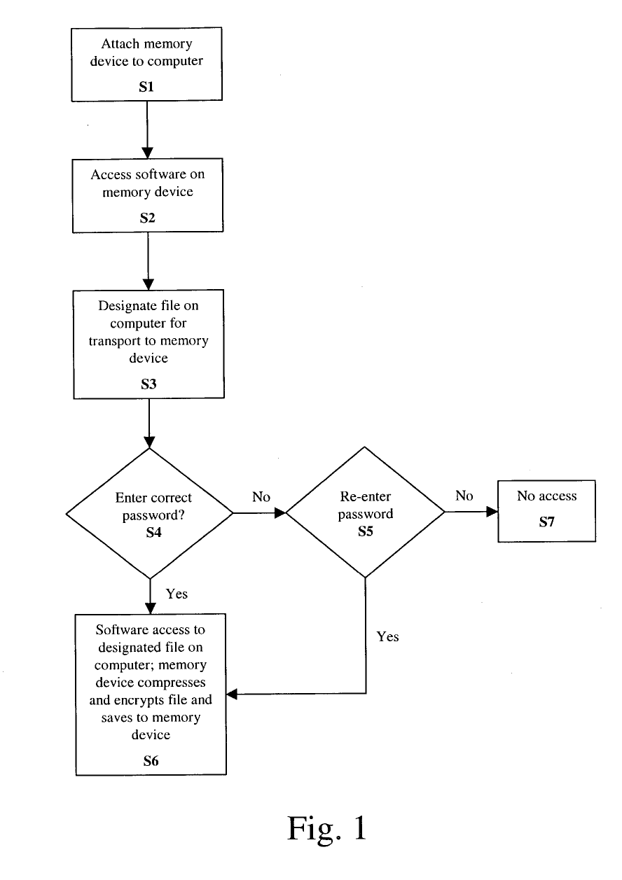

Referring to FIG. 1, the process of using the device in a preferred embodiment is disclosed. First, the memory device is attached, using the methods described herein, to the computer where the original files are located S1. The user then invokes the software already resident on the memory device S2. Using the software, the user designates the files to be transported S3, selects a password to be used S4, and commands the software to encrypt the files S6. Optionally, the software may compress the files before encryption. If the user enters an incorrect password, the user is given another opportunity S5 before access is restricted S7. The software then encrypts the files selected by the user, saving the encrypted version of the files to memory on the memory device. The memory device includes a folder called Encrypted Files in the preloaded file structure of the software, but additional folders may be set up or added. The user then disconnects the memory device from the origin computer. At this point, the user has a portable memory device containing the encrypted files.

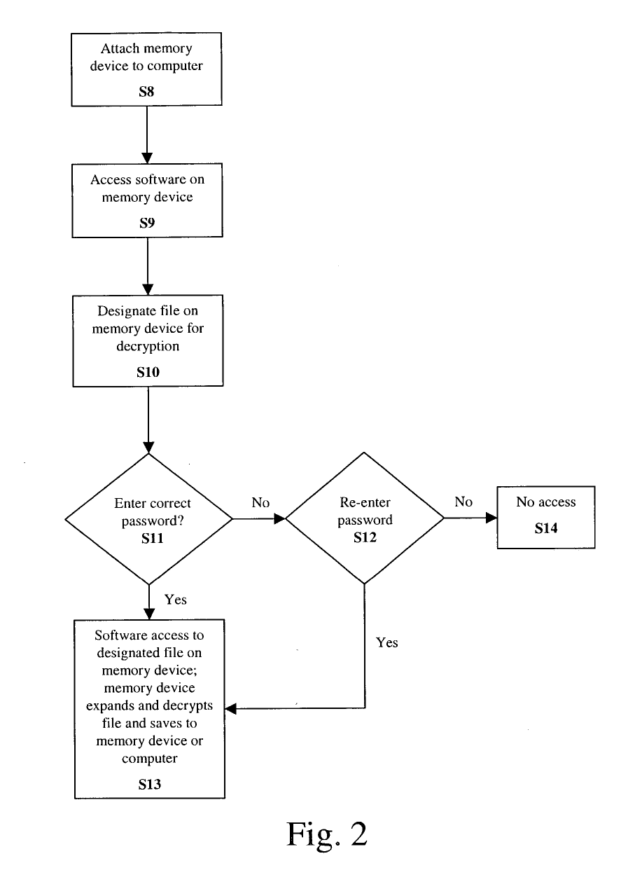

Referring to FIG. 2, in order to access these files, the user simply needs to similarly attach the memory device to another computer S8. The user attaches the memory device to the destination computer using the USB port of that computer, or similar method utilized for the origin computer. The user invokes the software resident on the memory device S9. Using the software, the user selects the desired encrypted files on the memory device S10, enters the pre-selected password S11, and commands the software to decrypt the files S13. If the user enters an incorrect password, the user is given another opportunity S12 before access is restricted S14. The software then decrypts and expands, if necessary, the files indicated by the user, saving the decrypted version of the files to the destination computer, if it is a secure computer, or, optionally, back to the memory device if the user does not want the decrypted files saved on an insecure computer. Files are decrypted to the Decrypted Files folder of the preloaded file structure at the target or destination computer. The memory device may then be disconnected from the destination computer. Optionally, the origin computer may also be the destination computer should a user desire to store encrypted files in a location other than the origin computer.

The software provides encryption-based privacy for both individuals and corporations. In one exemplary embodiment, the software may be loaded on the memory device via the Microsoft Windows® (Windows® is a registered trademark of the Microsoft Corporation, Inc.) operating system by copying the software to a USB Flash Drive using standard Windows® file utilities such as Windows Explorer®. The product, however, is not necessarily limited to Windows® operating systems. The software application is written in the C++ computer programming language, and currently compiled to run under most Microsoft Windows® operating systems. It may also be compiled to run under UNIX®, Linux®, Macintosh® (Macintosh® and Mac® are registered trademarks of the Apple Computer Corporation, Inc.) and other computer operating systems as well.

The software application that compresses/expands and encrypts/decrypts files consists of two parts. The first part is a core containing a compression routine, an encryption algorithm, and a process to drive one or more files through encryption and/or decryption. The second part contains a user interface to collect command data from the user, format it, and pass it to the core.

Regarding the first part of the software application, the user may designate two functions, i.e., compression and encryption, to be performed on the computer file in operating the software. The compression is performed in order to eliminate redundant and/or repeating characters in the plaintext to ensure such patterns cannot be used to attack the encryption. The compression step is optional. The software may compress every file, none of the files, or files that are a certain size. For example, if a non-compressed file is larger than 1 Mb, the software may automatically compress the file. Once the file is compressed, an encryption routine, based on the standard algorithm known as Blowfish, or any other 64-bit or greater block cipher algorithm known in the art, is run to perform the encryption.

The Blowfish algorithm is a 64-bit block cipher algorithm with a variable key length. It consists of two parts; key expansion and data encryption. Key expansion converts a key of up to 448 bits into several subkey arrays totaling an 8192 byte array with a key value from 8 to 448 bits. Data encryption consists of a simple function iterated multiple times. Each round consists of a key-dependent permutation, and a key and data dependent substitution. All operations are additions and XORs on 32-bit words. The only additional operations are indexed array data lookups per round. The algorithm uses a large number of subkeys, and these must be precomputed by the application prior to any data encryption or decryption. The Blowfish algorithm is fully described by its originator, Bruce Schneier, in his book Applied Cryptography (ISBN: 0-471-11709-9) published in 1996 by John Wiley and Sons, Inc. One of ordinary skill in the art recognizes that other algorithms for encryption are readily available.

First, the file is compressed. In compressing the file, the software uses a proprietary compression routine for the Blowfish algorithm. With respect to the compression routine, the software and method is unique in that software selects strings of characters from an input file of from 2 to 127 identical bytes. Those bytes are then represented as a 2-byte value in the compressed output file corresponding to the original file. Second, the file is encrypted. In encrypting the file, the software uses a form of the Blowfish algorithm for its encryption and decryption processes.

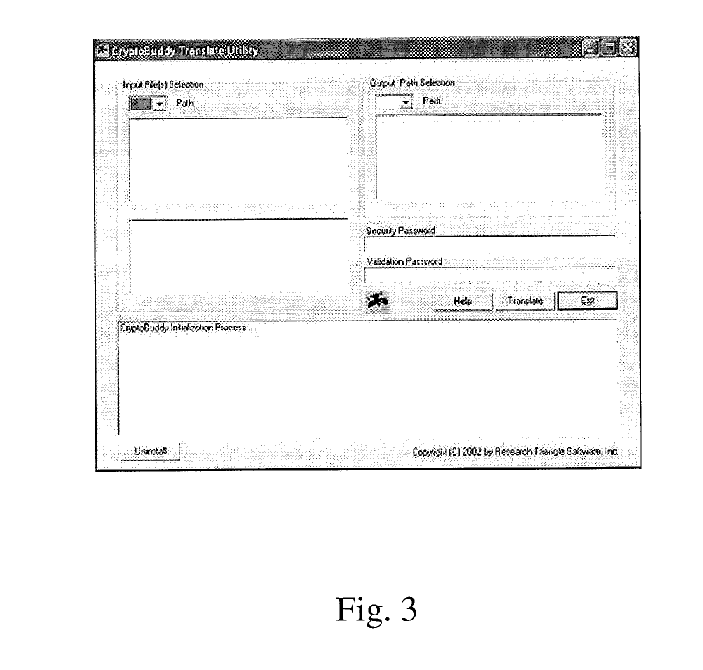

The second part of the software application involves the user interface. The software is easy to use, requiring a few simple steps for protecting computer files. Referring to FIG. 3, when the application is run on a computer running a 32-bit Windows®-based operating system the user interface operation screen appears.

The software interface accepts application control parameters and runs the encryption/decryption process. The first step in operating the software is for the user to designate the file to be encrypted/decrypted with the “Input File Selection” frame. Then the user must designate the output file directory with the “Output Path Selection” frame. The user must then supply a password in the “Security Password” box. This password is also entered in the “Validation Password” box to verify it has been typed correctly. By clicking the button marked “Translate,” the application processes the requested operation, showing steps in the dialog box at the bottom of the screen as they complete. Other buttons are provided to “Exit” the application, access the “Help” files, or “Uninstall” the application from the computer if necessary.

The user interface is custom for each operating system environment. The application contains no operating system dependencies except the user interface. Additionally, the software application is contained strictly within its own executable file with no additional DLL (Dynamic Link Library) files other than those in the existing operating system necessary for operation, and does not integrate into other applications, thereby running as a stand-alone system.

In operation, the software will create a file extension identified as “.cip” for files that have been encrypted. In this manner, the software automatically knows whether to encrypt or decrypt a file. More specifically, if a file is selected which does not include the “.cip” extension, the software recognizes that the operation to be performed is an encryption operation. If a file is selected which includes the “.cip” extension, then the software recognizes that the operation to be performed is a decryption operation. In this manner, encryption and decryption can be performed automatically, without the complication of the user having to select and recognize what operation is to be performed on a file.

The embodiments described herein are intended to be exemplary, and while including and describing the best mode of practicing, are not intended to limit the invention. Those skilled in the art appreciate the multiple variations to the embodiments described herein which fall within the scope of the invention.

1. A method of securing a computer file, the method comprising the steps of:
substantially applying a memory device to a first computer;
operating software loaded on the memory device configured to recognize the computer file;
transferring the computer file to the memory device from the first computer;
encrypting the computer file using the software on the memory device;
substantially removing the memory device from the first computer;
substantially applying the memory device with the encrypted file to a second computer; and
decrypting the computer file using the software on the memory device.

2. The method of claim 1, further comprising the step of identifying a file extension with the software on the memory device to determine whether the computer file is already encrypted or needs to be decrypted.

3. The method of claim 1, further comprising the step of compressing a non-encrypted file for encryption.

4. The method of claim 3, wherein the software on the memory device selects strings of characters from the computer file of approximately 2 to 127 identical bytes, wherein those bytes are then represented as a 2-byte value in a compressed output file corresponding to the original computer file.

5. The method of claim 3, further comprising the step of expanding a computer file that has been decrypted.

6. The method of claim 1, wherein the first computer and the second computer are the same computer.

7. An operating system for software on a memory device for handling computer files, the software operating system operates when the memory device is run on a computer, the software operating system comprising:
a user interface configured for designating a file to be encrypted or decrypted;
an output file directory configured for receiving designated files;
a password for access to the operating system to ensure an authorized user; and
an encryption algorithm for encrypting and decrypting files.

8. The method of claim 7, wherein the software operating system is independent from an operating system of the computer except for the user interface.

9. A memory device for handling files to be accessed on a first computer, allowing a user to securely transport the files from the first computer to at least a second computer, the memory device comprising:
a portable device removably attached to the computer; and
software loaded on the portable device capable of encryption and decryption, wherein the software is operated from the device.

10. The memory device of claim 9, wherein the portable device removably attaches to the first computer and the at least a second computer at a universal serial bus port.

11. The memory device of claim 9, wherein the portable device removably attaches to the first computer and the at least a second computer using wireless or multimedia application connectivity.

12. The memory device of claim 9, wherein the portable device is selected from the group consisting of a writable compact disc, a portable storage media, a mobile phone, a data storage media, a floppy disk, a personal digital assistant, and a portable e-mail device.

13. The memory device of claim 9, further comprising a preloaded file structure utilizing operating system utilities, the preloaded file structure comprising at least two file directories including an encrypted file directory and a non-encrypted file directory, wherein the files in the encrypted file directory are created for transport at the first computer and the files in the non-encrypted file directory are received for decryption at the second computer.

14. A method for protecting at least one file on a memory device, the method comprising the steps of:
substantially attaching the memory device to an origin computer, wherein the at least one file is located on the origin computer, and wherein the at least one file is accessible through the attached memory device;
operating software resident on the memory device via the origin computer;
designating the at least one file to be transported;
selecting a password for user authorization;
commanding the software to encrypt the at least one designated file;
compressing and encrypting the at least one designated file;
saving the at least one designated file on the memory device;
substantially disconnecting the memory device from the origin computer;
transporting the memory device to a destination computer;
substantially attaching the memory device to the destination computer;
operating the software resident on the memory device via the destination computer;
selecting the at least one designated file on the memory device;
entering the password for user authorization;
commanding the software to decrypt the at least one file;
decrypting the at least one file;
expanding the at least one file;
saving the at least one file to the memory device or the destination computer; and
substantially disconnecting the memory device from the destination computer.

15. The method of claim 13, wherein the at least one file is compressed and encrypted into a designated folder on the memory device.

16. The method of claim 13, wherein the at least one file is decrypted and expanded from a designated folder on the memory device.

17. The method of claim 13, wherein the origin computer is the destination computer.

18. A method for securely transferring at least one computer file, the method comprising the steps of:
initializing a user interface on a computer;
identifying the at least one computer file to be transferred from the computer;
determining a file extension of the at least one computer file, wherein the file extension signifies whether the at least one computer file is compressed or encrypted;
setting a password for a user to access the at least one computer file, wherein access to the at least one computer file facilitates at least one of encryption, decryption, compression, and expansion of the at least one computer file; wherein
if the at least one computer file is not compressed, compressing the at least one computer file;
if the at least one computer file is compressed, determining whether to expand or encrypt the at least one computer file;
if the at least one computer file is not encrypted, encrypting the at least one computer file or expanding the at least one computer file; and
if the at least one computer file is encrypted, determining whether to decrypt the at least one computer file.

19. A computer program product comprising a computer usable medium having control logic stored therein for causing a computer to secure at least one computer file, the control logic comprising:
computer readable program code means for causing the computer to initialize a user interface for utilization of the computer program product;
computer readable program code means for causing the computer to use a password for user access to at least one computer file;
computer readable program code means for causing the computer to compress at least one computer file;
computer readable program code means for causing the computer to expand at least one computer file;
computer readable program code means for causing the computer to encrypt at least one computer file;
computer readable program code means for causing the computer to decrypt at least one computer file; and
computer readable program code means for causing the computer to save the at least one computer file.
